(19) United States
(12) Patent Application Publication
(10) Pub. No.: US 2019/0326086 A1
(43) Pub. Date: Oct. 24, 2019

(54) SWITCHING CONTACT ARRANGEMENT

(71) Applicant: Phoenix Contact GmbH & Co. KG, Blomberg (DE)

(72) Inventor: Ralf Hoffmann, Berlin (DE)

(21) Appl. No.: 16/391,501

(22) Filed: Apr. 23, 2019

(30) Foreign Application Priority Data
Apr. 24, 2018 (BE) BE2018/5274

(51) Int. Cl. H01H 50/56; H01H 51/08; H01H 50/18

(52) U.S. Cl. CPC H01H 50/56; H01H 2205/002; H01H 50/18; H01H 51/08

(57) ABSTRACT

Methods, systems, and devices for a switching contact arrangement for a relay are described. A switching contact arrangement may include a first contact carrier including a first contact plug and a first contact pole in a first switching plane, a second contact carrier including a second contact plug and a second contact pole in a second switching plane, and a contact spring arranged between the first switching plane and the second switching plane. The contact spring may include a third contact carrier, a third contact plug, a third contact pole facing the first contact pole of the first contact carrier, and a fourth contact pole facing the second contact pole of the second contact carrier. The contact carriers may be acted upon by electrical signals via the respective contact plugs.

### CROSS-REFERENCE TO RELATED APPLICATIONS

This application claims priority to Belgian Patent Application No. BE2018/5274, entitled “Switching Contact Arrangement” and filed on Apr. 24, 2018 by the Applicant of this application. The entire disclosure of the Belgian application is incorporated herein by reference for all purposes.

### BACKGROUND

The present disclosure relates to a switching contact arrangement for a relay.

Relays may comprise an electromechanical switching group that switches at least between a first switching state and a second switching state. The electromechanical switching group can comprise a movable contact element that may be moved back and forth between the first switching contact and a second switching contact parallel to a longitudinal orientation of an armature of the relay.

In some cases, the individual components of the electromechanical switching group are produced in a plurality of production steps, and the assembly of the electromechanical switching group and/or the production costs of the electromechanical switching group may be proportional to a number of production steps.

### SUMMARY

It is the object of the present disclosure to provide a further efficient switching contact arrangement that may be produced with a reduced number of production steps. For example, an enhanced switching contact arrangement may include a first contact carrier, a second contact carrier and a contact spring, wherein the first contact carrier may be arranged below the contact spring and the second contact carrier above the contact spring. Furthermore, the contact spring can be configured to produce an electrical connection at a first contact pole with the first contact carrier and to produce an electrical connection at the second contact carrier at a second contact pole, wherein the first contact pole may be arranged laterally offset from the second contact pole, while the contact plug for electrical connection of the contact carriers and the contact spring may be arranged side by side.

According to a first aspect, the disclosure relates to a switching contact arrangement for a relay. The switching contact arrangement may comprise a first contact carrier including a first contact plug and a first contact pole, wherein the first contact pole may be arranged in a first switching plane and the first contact plug may be formed integrally with the first contact carrier, and wherein the first contact carrier can be acted upon via the first contact plug with an electrical signal. Furthermore, the switching contact arrangement may comprise a second contact carrier include a second contact plug and a second contact pole, wherein the second contact pole may be arranged in a second switching plane that may be arranged in parallel spaced apart from the first switching plane, and wherein the second contact carrier can be acted upon via the second contact plug with a further electrical signal.

Furthermore, the switching contact arrangement comprises a contact spring, wherein the contact spring may have a third contact carrier and a third contact plug, wherein the contact spring may be arranged between the first switching plane and the second switching plane, and wherein the third contact carrier can be acted upon via the third contact plug with a third electrical signal, and wherein the contact spring has a third contact pole facing the first contact pole, and a fourth contact pole facing the second contact pole, and wherein the third contact pole may be laterally offset next to the fourth contact pole.

The switching contact arrangement may be used in a relay with a reduced overall width of 3 mm. In some cases, the switching contact arrangement configured for use in a 3 mm relay may be produced more cost efficiently than a switching contact arrangement configured for use in a 5 mm relay. In addition, mounting of the switching contact arrangement in the relay can be simplified.

The components of the switching contact arrangement may be arranged in the first switching plane or in the second switching plane, wherein the contact spring and the second contact carrier can each have a transition region that makes a connection between the first switching plane and the second switching plane. Accordingly, a number of bending operations used to produce the switching contact arrangement can be reduced.

To produce the switching contact arrangement, planar semi-finished products may be used. The planar semi-finished products may be shaped by punching, riveting and bending to form the switching contact arrangement. Due to the planar shape of the contact carrier and the contact spring, the switching arrangement can be produced by means of a combined punching-bending-process step and a riveting process step.

In one example, the contact spring comprises a spring element. The spring element may be configured to generate a restoring force by a deflection of the contact spring from a rest position, driving the contact spring back into the rest position. Accordingly, the third contact carrier can be resiliently mounted on the second contact carrier or on the first contact carrier, wherein, respectively, the second contact pole rests on the fourth contact pole or the first contact pole rests on the third contact pole.

Furthermore, in a rest position of the contact spring, the first contact pole can be spaced apart from the third contact pole, while the second contact pole can be spaced apart from the fourth contact pole. Accordingly, the switching contact arrangement can have three switching states. In a first switching state, the three contact carriers can be electrically separated from each other, in a second switching state, the first contact carrier and the third contact carrier can be electrically connected to each other and/or in a third switching state, the second contact carrier and the third contact carrier can be electrically connected. Preferably, in a rest position of the contact spring, the third contact carrier may be electrically connected to the first contact carrier or to the second contact carrier, wherein the respective contact poles rest on one another. A deflection of the contact spring causes a separation of the electrical contact between the previously superimposed contact poles, while the respective other contact pole pair may be electrically connected together.

In one example, the first contact carrier and the second contact carrier may be formed from a first sheet metal blank, while the contact spring may be formed from a second sheet metal blank.

In the case of a view along a surface normal of the first switching plane and/or the second switching plane, the switching contact arrangement has overlapping surfaces between the first contact carrier and the third contact carrier and/or the second contact carrier and the third contact carrier. In some examples, the surfaces may overlap in the region of the contact poles. In some examples, the surfaces of the first contact carrier and the second contact carrier may be nonoverlapping, and the first contact carrier and the second contact carrier may be produced from the same sheet metal blank. The contact spring with the third contact carrier can be made of a further sheet metal blank and be inserted parallel to the first switching plane and/or the second switching plane between the first contact carrier and the second contact carrier.

In one example, the first contact plug, the second contact plug and the third contact plug may be formed from the first sheet metal blank. In some examples, the contact plug and the first contact carrier and the second contact carrier can be produced from the same sheet metal blank in order to achieve efficient production of the switching contact arrangement with a reduced number of production steps.

In one example, the first contact plug, the second contact plug and the third contact plug may be arranged in the first switching plane. Accordingly, the contact plug can be arranged in a row that may be arranged perpendicular to a width of a relay, so that the contact plug can be arranged within the width of the relay.

In one example, the third contact plug has at least one connection point. The connection point may be configured to connect the third contact carrier to the third contact plug electrically and to fix it mechanically. Accordingly, the contact spring can include two parts from two different sheet metal blanks. For example, the third contact plug and the third contact carrier can each be made from separate sheet metal blanks and subsequently joined together at the contact point. In some cases, the third contact plug and the third contact carrier may be made by punching and bending. In some cases, the third contact plugged may be riveted, pressed, welded and/or soldered to the third contact carrier. Furthermore, the third contact carrier can be connected with the third contact plug by means of a plug connection.

In one example, the first contact carrier in the first switching plane may be L-shaped, while the second contact carrier may be angled to overcome the distance between the second contact pole in the second switching plane and the second contact plug in the first switching plane. Accordingly, a gap may be created between the first contact carrier and the second contact carrier. In some cases, the contact spring and/or the third contact carrier may be inserted into the gap. In the region of the contact poles, the arrangement of the first contact carrier, the third contact carrier and, finally, the second contact carrier, as seen from the first switching plane. In some cases, the second contact carrier may be bent in a z-shape and/or at right angles in order to overcome the distance to the second contact plug.

In one example, the spring element may be arranged between the third contact carrier and the third contact plug and may be z-shaped to bridge the distance between the first switching plane and the second switching plane.

In one example, the respective contact poles may be riveted and/or welded to the respective contact carrier. Furthermore, the contact poles can also be soldered to the contact carrier. In one example, the contact poles can be formed by shaping the respective contact carrier. The contact poles may have a curved shape. An opening can be provided in the contact carrier for a rivet connection between a contact pole and a contact carrier. The contact poles can be made more resistant to contact erosion relative to the contact carriers, in order to increase a possible number of switching operations involving an electrical load between the contact poles.

In one example, the switching contact arrangement comprises a coupling arm. The coupling arm may be coupled to an armature of a magnet system, wherein the coupling arm may be configured to effect a translation of the contact spring perpendicular to a longitudinal axis of the armature with a force acting on the coupling arm by means of the armature, in order to connect the contact spring to one of the contact carriers electrically. Accordingly, the contact spring can alternately electrically connect the first contact pole to the third contact pole, and the second contact pole to the fourth contact pole. The coupling arm may be formed integrally with the contact spring. Furthermore, the coupling arm and/or a further coupling arm can be integrally formed laterally next to the third contact pole and/or the fourth contact pole, wherein the armature simultaneously acts on the coupling arms in order to prevent torsion of the contact spring about a longitudinal axis of the contact spring.

In one example, the coupling arm may be arranged laterally next to the third contact carrier and has a coupling region. The coupling region may be configured to receive a lever arm of the magnet system at least partially in a form-fitting manner. Accordingly, the coupling arm can be coupled with the lever arm mechanically fixed to the magnet system, resulting in an efficient transmission of power from the magnet system to the contact spring. The positive connection between the lever arm and the coupling arm can be achieved, for example, by engaging a cylindrical projection of the lever arm in an opening of the coupling arm. A latching connector in the form of a latching pin and/or a latching recess into which the coupling arm engages can further be formed on the lateral surface of the cylindrical projection. The connection between the coupling arm and the lever arm may be formed free of play in order to implement a translation of the lever arm with as little loss as possible in a translation of the coupling arm and accordingly the contact spring. With the form-fitting connection, the coupling arm can be moved both in the direction of the first switching plane as well as opposite in the direction of the second switching plane.

In one example, the contact spring in the rest position may be electrically isolated from the first contact carrier and/or the second contact carrier. Accordingly, with upon deflection of the contact spring, a contact pole pair, for example the second contact pole and the fourth contact pole, can be electrically separated, while a further contact pole pair, for example, the first contact pole and the third contact pole can be electrically connected.

In one example, the first contact carrier, the second contact carrier and/or the third contact carrier have openings for receiving pins of a relay housing in order to fix the switching contact arrangement in a relay housing. Accordingly, the relay housing can be efficiently held in the relay housing. For example, the first contact carrier and the second contact carrier can be mechanically fixedly connected to the relay housing. In some examples, a part of the contact spring comprising the connection point and the third contact plug may be firmly anchored in the relay housing by means of a mechanical connection between the openings and the pins of the relay housing. The spring element and the third contact carrier can be arranged to be movable relative to the relay housing.

In some cases, the second contact carrier may have portions in the first switching plane and further portions in the second switching plane and may be fixed in the respective switching plane by means of connections between pins of the relay housing and corresponding openings in the portions of the second contact carrier. Furthermore, the switching contact arrangement can be fixed in the relay housing by means of clamping connections to the edges of the contact carrier and/or by means of material-bonding connections, such as adhesive connections.

In one example, the switching contact arrangement comprises a first offset portion. The first offset portion may be arranged on the first contact plug and may be configured to offset the first contact plug along a surface normal of the first switching plane by a predetermined distance from the first switching plane. The first offset portion may be formed in one piece with the first contact plug and/or the first contact portion. In some examples, the first offset portion may be formed from a contact carrier strip.

With the first offset portion, the first contact plug can be arranged at a predetermined position of the relay width. For example, the first contact plug can be arranged in the first switching plane, in the second switching plane, or in the middle between the first switching plane and the second switching plane. Furthermore, any predetermined position of the first contact carrier may be limited by the width of the relay. As a result, the position of the first contact carrier can be adapted to a position of an associated contact socket in a terminal block for receiving the relay. Furthermore, the second contact plug and/or the third contact plug can be arranged over a respective offset portion in a predetermined position. In some cases, the first contact plug, the second contact plug and the third contact plug can be arranged in one plane. In one example, the contact plugs may be each offset from one another.

In one example, the switching contact arrangement comprises a second offset portion and a third offset portion. The third offset portion may be arranged with a lateral offset on the contact spring, and/or the second contact plug may be arranged with a lateral offset on the second offset portion. The offset portions may be configured to arrange the respective contact plug offset along a surface normal of the first switching plane at a predetermined distance from the first switching plane.

By means of the laterally offset arrangement of the third offset portion, the available space can be used for attachment of the contact spring and/or for an arrangement of the spring element in the longitudinal direction of the contact spring. In some cases, the available space in the longitudinal direction of the contact spring space may not be reduced by the offset portion. In an efficient manner, the third offset portion can be arranged offset laterally to the longitudinal direction of the contact spring for efficient use of the space. In some cases, the space may be the minimum distance of one contact plug to the other.

According to a second aspect, the disclosure relates to a method for producing a switching contact arrangement for a relay, with punching of the first contact carrier and of the second contact carrier in a contact carrier strip; attaching the first contact pole to the first contact carrier and the second contact pole to the second contact carrier; bending a contact portion of the second contact carrier into the second switching plane, wherein the second contact pole may be arranged on the contact portion; punching the contact spring in a contact spring strip; attaching the third contact pole and the fourth contact pole to a third contact carrier of the contact spring; bending the contact spring to form the spring element, wherein the third contact carrier, on which the third contact pole and the fourth contact pole may be arranged, has a smaller distance to the second switching plane than the third contact plug to the second switching plane; connecting the contact carrier strip to the contact spring strip at the junction of the third contact plug; separating the contact spring from the contact spring strip; and disconnecting the contact plug from the contact carrier strip.

With the possible geometric arrangement of the contact carrier and contact plug according to the method, the switching contact arrangement in the relay housing may be used in an assembly step. Furthermore, in a single further assembly step, the magnet system can be used with the lever arm in the relay housing and connected to the switching contact arrangement, so that the number of production steps for producing a relay with the switching contact arrangement may be reduced.

In some cases, the magnet system can be inserted into the relay housing without further adjustment and/or adjustment steps. The magnet system can also be held in the relay housing through pins of the relay housing.

The contact spring strip can be arranged in a plane perpendicular to the contact carrier strip to interleave the contact carrier and the contact spring by a translation of the contact carrier strip and/or the contact spring strip.

The second contact carrier can may be an NC fixed contact carrier. In some cases, the NC fixed contact carrier may be bent in a z-step manner. The second contact pole can rest on the fourth contact pole in a switched-off state of the relay.

In one example, the method can be carried out by means of a stamping/bending machine in order to effect joint processing of the contact carrier strip with the contact spring strip.

Accordingly, the punching of the contact carrier strip, by which the first contact carrier of the second contact carrier and/or, at least partially, the first contact plug, the second contact plug and the third contact plug, may be formed, and the bending of the second contact carrier so that the second contact carrier has a contact portion which may be arranged in the second switching plane, which may be integrally connected to the second contact plug, which may be arranged in the first switching plane may occur concurrently.

Furthermore, the contact spring can be formed from the contact spring strip, while the spring element can be integrally formed in the contact spring in a simultaneous bending and punching process step by means of stamping and bending machines.

In one example, after punching the contact spring in the contact spring strip, the contact spring strip may be wound onto a reel in order to produce the switching contact arrangement in an assembly of a production line.

In one example, after punching the first contact carrier, the second contact carrier and the third contact carrier in the contact carrier strip, the contact carrier strip may be wound onto a further reel.

### BRIEF DESCRIPTION OF THE DRAWINGS

Further examples will be explained with reference to the accompanying figures, wherein:

FIG. 1 shows a switching contact arrangement as described herein;

FIGS. 2A and 2B show a sub-method of a method for producing contact carriers and contact plugs as described herein;

FIGS. 3A, 3B, and 3C show a further sub-method of a method for producing a contact spring as described herein;

FIGS. 4A and 4B show a method for producing a switching contact arrangement as described herein;

FIG. 5 shows a method for producing a relay as described herein;

FIG. 6 shows a method for producing a switching contact arrangement and for arranging the switching contact arrangement in a relay as described herein;

FIG. 7 shows a contact spring as described herein; and

FIG. 8 shows a switching contact arrangement as described herein.

### DETAILED DESCRIPTION

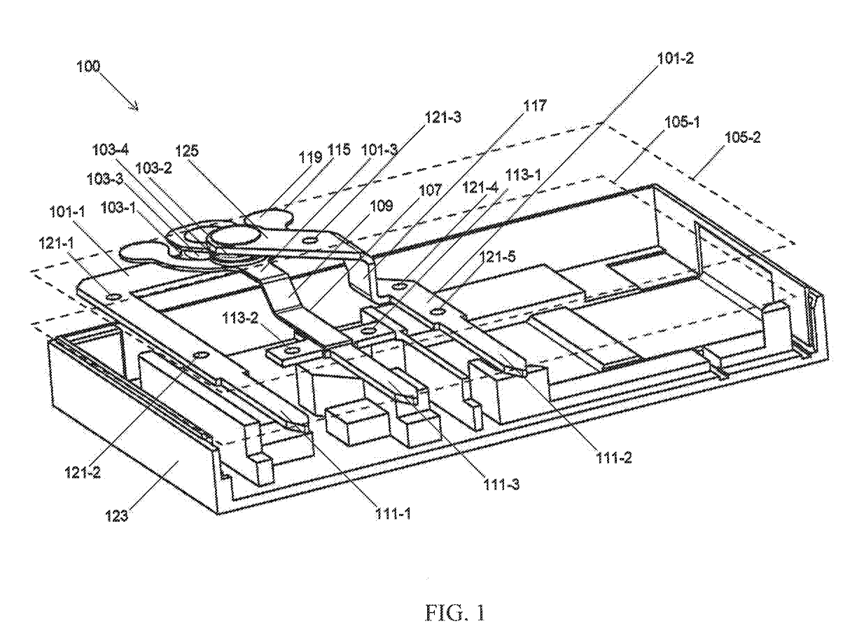

FIG. 1 shows a schematic perspective view of a switching contact arrangement 100 for a relay. The switching contact arrangement 100 comprises a first contact carrier 101-1, which comprises a first contact plug 111-1 and a first contact pole 103-1, wherein the first contact pole 103-1 may be arranged in a first switching plane 105-1, while the first contact plug 111-1 may be formed integrally with the first contact carrier 101-1, and wherein the first contact carrier 101-1 can be acted upon via the first contact plug 111-1 with a first electrical signal.

Furthermore, the switching contact arrangement 100 comprises a second contact carrier 101-2, which comprises a second contact plug 111-2 and a second contact pole 103-2, wherein the second contact pole 103-2 may be arranged in a second switching plane 105-2, which may be spaced parallel from the first switching plane 105-1, and wherein the second contact carrier 101-2 can be acted upon via the second contact plug 111-2 with a second electrical signal.

Furthermore, the switching contact arrangement 100 comprises a contact spring 107, which has a third contact carrier 101-3 and a third contact plug 111-3, wherein the contact spring 107 may be arranged between the first switching plane 105-1 and the second switching plane 105-2, and wherein the third contact carrier 101-3 can be acted upon by the third contact plug 111-3 with a third electrical signal. The third contact plug 111-3 has connection points 113-1, 113-2, which may be configured to connect the third contact carrier 101-3 with the third contact plug 111-3 electrically and to fix it thereto mechanically.

The contact spring 107 has a third contact pole 103-3, which faces the first contact pole 103-1, and a fourth contact pole 103-4, which faces the second contact pole 103-2. Furthermore, the third contact pole 103-3 may be arranged laterally offset next to the fourth contact pole 103-4.

Furthermore, the contact spring 107 comprises a spring element 109, which may be configured to generate a restoring force during a deflection of the contact spring 107 from a rest position and to drive the contact spring 107 back into the rest position. The spring element 109 may be arranged between the third contact carrier 101-3 and the third contact plug 111-3 and may be z-shaped in order to bridge a distance between the first switching plane 105-1 and the second switching plane 105-2.

The first contact plug 111-1, the second contact plug 111-2 and the third contact plug 111-3 may be arranged in the first switching plane 105-1. The first contact carrier 101-1 may be formed to be L-shaped in the first switching plane 105-1, while the second contact carrier 101-2 may be angled in order to overcome the distance between the second contact pole 103-2 in the second switching plane 105-2 and the second contact plug 111-2 in the first switching plane 105-1.

Furthermore, the first contact carrier 101-1, the second contact carrier 101-2 and/or the third contact carrier 101-3 has openings 121-1, 121-2, 121-3, 121-4, 121-5 for receiving pins of a relay housing 123 in order to fix the switching contact arrangement 100 in a relay housing 123.

The respective contact poles 103-1, 103-2, 103-3,103-4 may be riveted and/or welded to the respective contact carrier 101-1, 101-2, 101-3. In some cases, at the respective junction between the contact poles 103-1, 103-2, 103-3, 103-4 and the contact carriers 101-1, 101-2, 101-3, recesses may be provided in order to efficiently produce a rivet connection, solder joint and/or welded joint. The switching contact arrangement 100 further comprises a coupling arm 115, which can be coupled to an armature of a magnet system.

The coupling arm 115 may be arranged laterally next to the third contact carrier 101-3 and has a coupling region 119 which may be configured to receive at least partially a lever arm 507 of the magnet system 503 in a form-fitting manner.

The contact spring 107 may be electrically isolated in the rest position of the first contact carrier 101-1.

The second contact carrier 101-2 comprises an offset portion 117 which may be arranged between the contact portion 125 and the second contact plug 111-2. The contact portion 125 may be configured to receive the second contact pole 103-2. The offset portion 117 may be configured to provide a parallel offset of the contact portion 125 relative to the second contact plug 111-2 by means of two curved portions, so that the contact portion 125 in the second switching plane 105-2 and the second contact plug 111-2 may be arranged in the first switching plane 105-1.

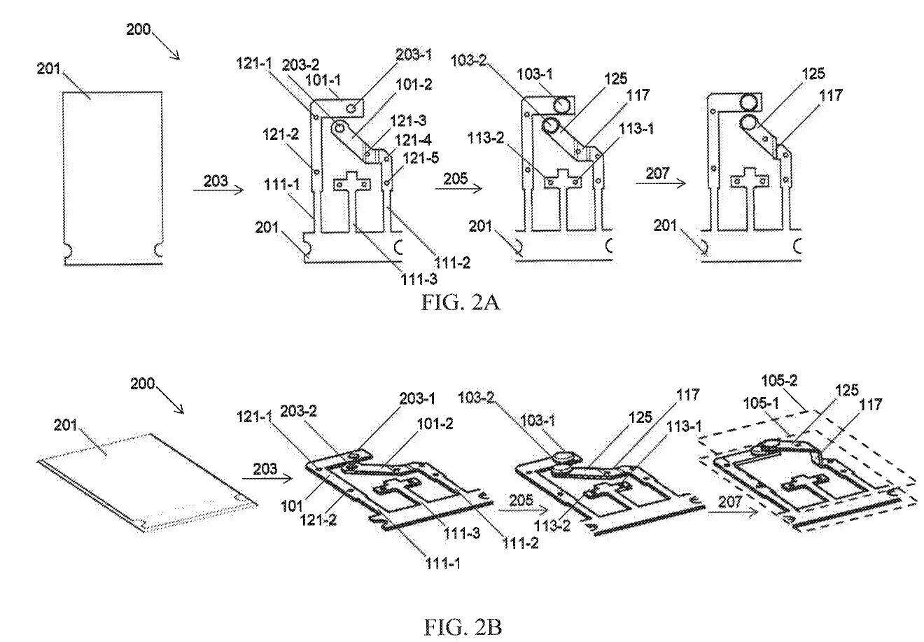

FIG. 2A shows a schematic representation of a sub-method 200 of the method for producing a switching contact arrangement 100 for a relay. The sub-method 200 comprises punching 203 of the first contact carrier 101-1 and the second contact carrier 101-2 in a sheet metal blank 201, and fixing 205 of the first contact pole 103-1 on the first contact carrier 101-1, and the second contact pole 103-2 on the second contact carrier 101-2. Furthermore, the method 200 comprises bending 207 a contact portion 125 of the second contact carrier 101-2 in the second switching plane 105-2, wherein the second contact pole 103-2 may be arranged on the contact portion 125. In some cases, bending 207 occurs on the offset portion 17. By bending 207, the second contact pole 103-2 can be aligned with first contact pole 103-1 and the third contact carrier 111-3.

A respective mounting location 203-1, 203-2 may be formed in the first contact carrier 101-1 and in the second contact carrier 101-2, and may be configured to receive the respective contact pole 103-1, 103-2. The mounting points 203-1, 203-2 may be in recesses or depressions which may be punched or embossed in the respective contact carrier 101-1, 101-2. Such a depression can also be formed as a curvature out of the plane of the drawing according to the plan view.

FIG. 2B shows a schematic perspective illustration of sub-method 200 of the method for producing a switching contact arrangement 100 according to the example shown in FIG. 2A. By bending 207 the contact portion 125 of the second contact carrier 101-2, the contact portion 125 originally formed in the first switching plane 105-1 may be arranged in the second switching plane 105-2.

The respective contact pole 103-1, 103-2 can be riveted onto the respective contact carrier 103-1, 103-2, wherein the first contact pole 103-1 can be aligned in the direction of the second switching plane 105-2 and/or the second contact pole 103-2 can be aligned in the direction of the first switching plane 105-1.

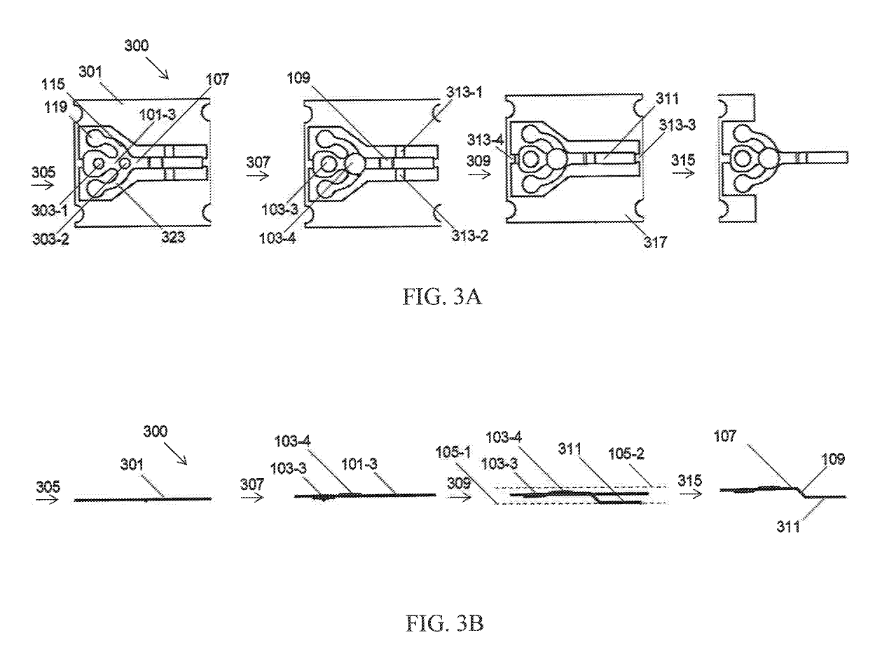

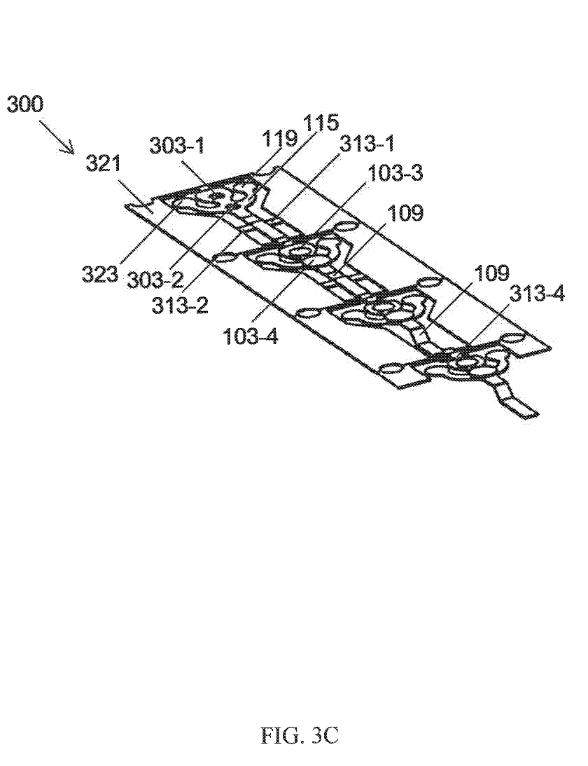

FIG. 3A shows a schematic illustration of a sub-method 300 of the method for producing a switching contact arrangement 100 for a relay. The sub-method 300 comprises punching 305 of the contact spring 107 in a second sheet metal blank 301 and attaching 307 the third contact pole 103-3 and the fourth contact pole 103-4 to a third contact carrier 101-3 of the contact spring 107. Furthermore, the sub-method 300 comprises bending 309 of the contact spring 107 to form the spring element 109.

The contact spring 107 comprises a first mounting location 303-1 and a second mounting location 303-2, wherein the first mounting location 303-1 may be configured to receive the third contact pole 103-3, and wherein the second mounting location 303-2 may be formed to receive the fourth contact pole 103-4. The third contact pole 103-3 can be arranged according to the plan view shown on an underside of the contact spring 107, while the fourth contact pole 103-4 can be correspondingly arranged on an upper side of the contact spring 107.

Furthermore, a further coupling arm 323 can be formed on the contact spring 107, which may be formed symmetrically to the coupling arm 115 with respect to a longitudinal axis of the contact spring 107.

Furthermore, the contact spring 107 before bending 309 of the contact spring 107 may be still connected to the second sheet metal blank 301 by holding struts 313-1, 313-2, 313-3. The holding struts 313-1, 313-2 can be removed in parallel to the molding of the spring element 109. Furthermore, the holding strut 313-3 can be removed together with a partial remainder 317 of the second metal sheet blank 301 including the contact spring 107. The removal 315 of the partial remainder and the holding strut 313-3 can be carried out as a separate method step or can be performed parallel to the shaping of the spring element 109 by the bending 309 of the contact spring 107. The contact spring 107 can finally be connected by a further holding strut 313-4 with the second sheet metal blank 301.

FIG. 3B shows a schematic side view of sub-method 300 according to the example shown in FIG. 3A. The third contact carrier 101-3, on which the third contact pole 103-3 and the fourth contact pole 103-4 may be arranged, has a smaller spacing from the second switching plane 105-2 than a connection portion 311 to the second switching plane 105-2. The spring element 109 may be bent in a z-shape and connects the third contact carrier 101-3 with the connection portion 311. The connection portion 311 may be configured to be connected to the third contact plug. In some cases, the connection may be riveted to the third contact plug.

FIG. 3C shows a schematic plan view of sub-method 300 according to the example shown in FIG. 3A. The individual method steps can be implemented stepwise on a particular continuous contact spring strip 321. Finally, the contact spring 107 can be connected with the contact spring strip 321 by a further holding strut 313-4 in order to wind the contact spring strip 321 on a reel after forming the contact spring 107.

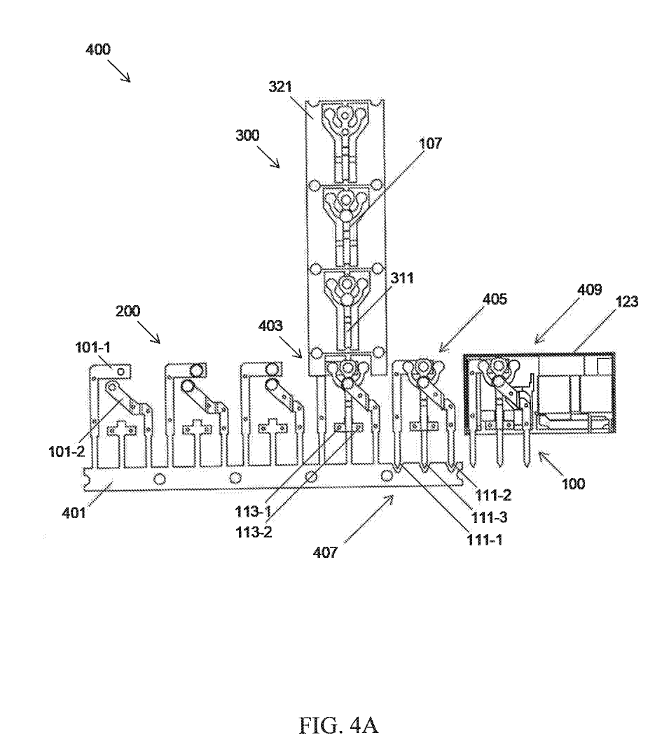

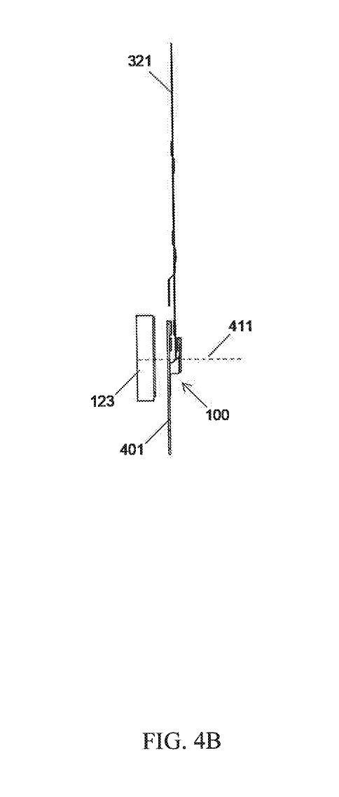

FIG. 4A shows a schematic illustration of a method 400 for producing a switching contact arrangement 100 for a relay. The method 400 comprises the sub-method 200 according to the example shown in FIG. 2A and the further sub-method 300 according to the example shown in FIG. 3C. The individual method steps of sub-method 200 can be implemented step-by-step on a particular continuous contact carrier strip 401. The contact plug 111-1, 111-2,111-3 can remain materially connected to the contact carrier strip 401, in order, after forming the contact carrier 101-1, 101-2 and the contact plug 111-1, 111-2, 111-3, to wind the contact carrier strip 401 on another reel.

Furthermore, the method 400 comprises the connection 403 of the contact carrier strip 401 with the contact spring strip 321 at the connection points 113-1, 113-2 of the third contact plug 111-3, disconnection 405 of the contact spring 107 from the contact spring strip 321, and further separation 407 of the contact plug 111-1, 111-2, 111-3 from the contact carrier strip 401. With the separation 407 of the contact plugs 111-1, 111-2, 111-3 from the contact carrier strip 401, the contact plugs 111-1, 111-2, 111-3 each have a tapered shape. In some examples, the ends of the contact plugs 111-1, 111-2, 111-3 can be triangular and/or tapered to form, for example, a respective contact tip.

Furthermore, the method 400 can include inserting 409 the switching contact arrangement 100 into the relay housing 123, wherein the switching contact arrangement 100 can be held in the relay housing 123 by means of a latching connection.

The contact carrier strip 401 can be brought together with the contact spring strip 321. In some examples, the contact carrier strip 401 may be brought together with the contact spring strip 321 at a right angle. At the intersection of the contact carrier strip 401 with the contact spring strip 321, the contact spring 107 can be separated from the contact spring strip 321 and simultaneously connected to the third contact plug 111-3 at the connection points 113-1, 113-2. The contact spring 107 can be carried over the connection points 113-1, 113-2 with the contact carrier strip 401. With the subsequent separation 407 of the contact plug 111-1, 111-2, 111-3 from the contact carrier strip 401, the switching contact arrangement 100 can be separated from the contact carrier strip 401 in order to subsequently insert the switching contact arrangement 100 in the relay housing 123. Accordingly, a plurality of switching contact assemblies 100 can be made of a continuous contact carrier strip 401 and a continuous contact spring strip 321.

FIG. 4B shows a schematic side view of the method 400 according to the example shown in FIG. 4A. The contact carrier strip 401 and the contact spring strip 321 may be offset from the relay housing 123. Accordingly, the switching contact arrangement 100 can be inserted parallel to a surface normal 411 of a bottom surface of the relay housing 123 in the relay housing 123.

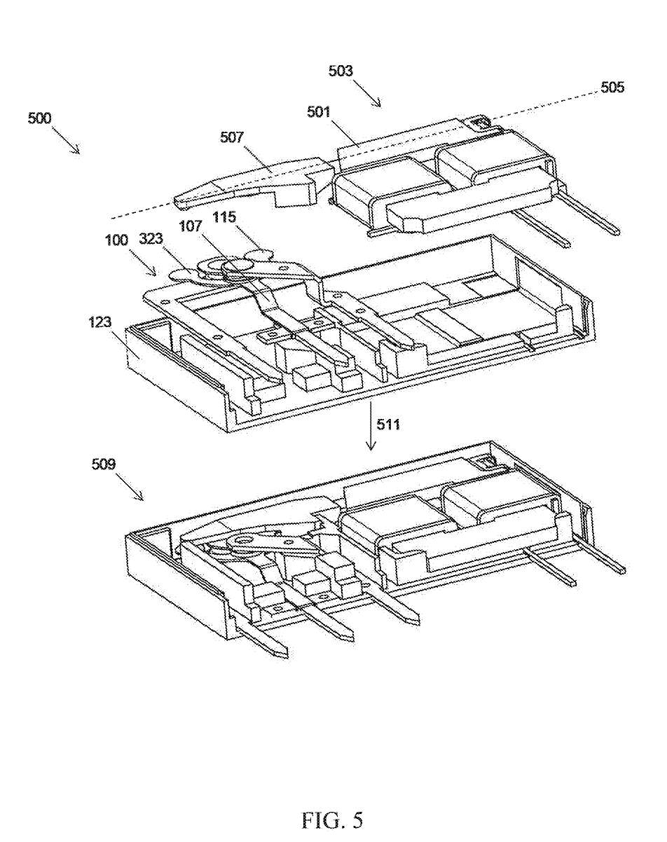

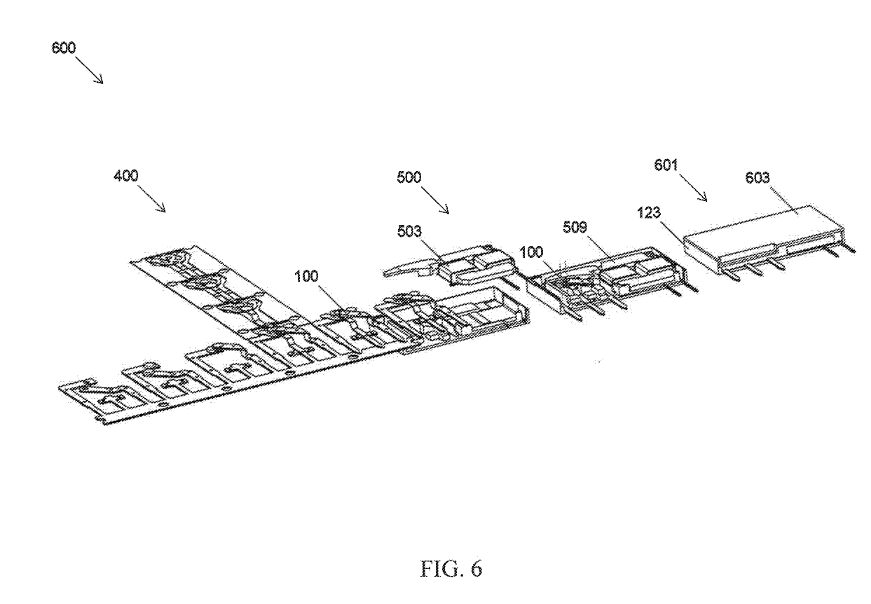

FIG. 5 shows a schematic perspective view of a method 500 for producing a relay 509. The method comprises mounting 511 of the magnet system 503 in the relay housing 123. The mounting 511 of the magnet system 503 takes place after inserting the switching contact arrangement 100 into the relay housing 123 The magnet system comprises an armature 501, which may be configured to be deflected electromagnetically, and a lever arm 507 that may be connected to the armature 501. The lever arm 507 may be configured to come to rest on at least one of the coupling arms 115, 323 and/or to be positively and/or materially connected to one of the coupling arms 115, 323. Deflection of the armature 501 can be transmitted via the lever arm 507 to at least one of the coupling arms 115, 323 in order to move the contact spring 107.

Upon a force acting on the coupling arm 115 by means of the armature 501, the coupling arm 115 may be configured to effect translation of the contact spring 107 perpendicular to a longitudinal axis 505 of the armature 501 in order to electrically conductively connect the contact spring 107 with one of the contact carriers 101-1, 101-2, 101-3.

FIG. 6 shows a schematic perspective view of a method 600 for producing a switching contact arrangement 100 and for arranging the switching contact arrangement 100 in a relay 509 in one example. The method 600 includes the method 400 for producing a switching contact arrangement 100 for a relay 509 according to the example shown in FIG. 4A. Furthermore, the method 600 includes the method 500 for producing a relay 509 according to the example shown in FIG. 5.

Furthermore, the method 600 comprises the placing 601 of a relay cover plate 603, which may be configured to close the relay housing 123 in order to protect from external influences the switching contact arrangement 100 arranged inside the relay housing and the magnet system 503.

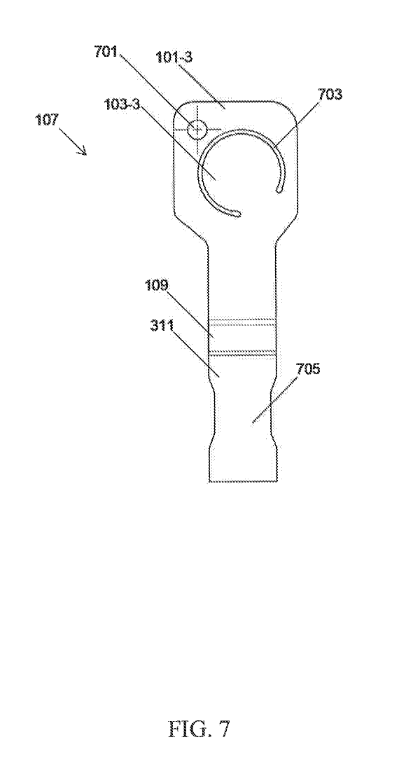

FIG. 7 shows a schematic representation of a contact spring 107 in one example. The contact spring 107 comprises a connecting portion 311 and a third contact carrier 101-3 with a spring element 109. The third contact carrier 101-3 has a rectangular surface with rounded corners, which tapers in the direction of the spring element 109 in, for example, a trapezoidal shape.

The contact spring 107 further comprises an opening 701, which may be arranged above a part-circular recess 703 in a corner of the contact carrier 101-3. The opening 701 may be a circular bore or punch opening. The part-circular recess 703 can be formed, for example, by an opening (e.g., a punch opening) running along a peripheral portion of a circle. The third contact pole 103-3 can be at least partially surrounded by the part-circular recess 703. Furthermore, the contact spring 107 has a width-reduced portion 705, which may be formed by symmetrical, opposite and/or trapezoidal recesses.

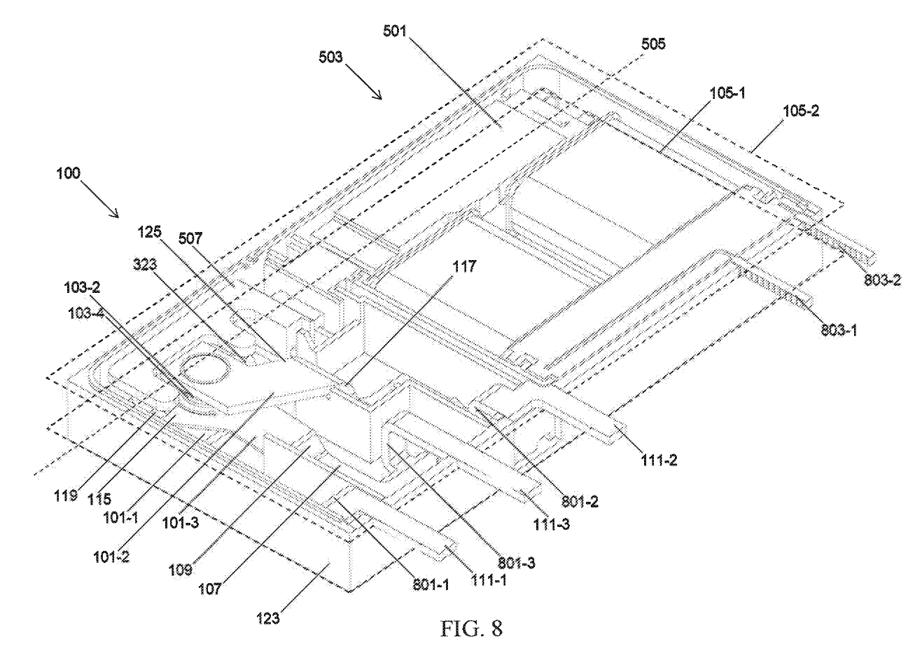

FIG. 8 shows a schematic perspective illustration of a switching contact arrangement 100 for a relay. The switching contact arrangement 100 comprises a first contact carrier 101-1, which comprises a first contact plug 111-1 and a first contact pole. The first contact pole may be arranged in the first switching plane 105-1, while the first contact plug 111-1 may be formed integrally with the first contact carrier 101-1.

Furthermore, the switching contact arrangement 100 comprises a second contact carrier 101-2, which comprises a second contact plug 111-2 and a second contact pole 103-2, wherein the second contact pole 103-2 may be arranged in the second switching plane 105-2, which may be spaced parallel from the first switching plane 105-1.

Furthermore, the switching contact arrangement 100 comprises a contact spring 107, which has a third contact carrier 101-3 and a third contact plug 111-3. The third contact carrier 101-3 may be arranged between the first switching plane 105-1 and the second switching plane 105-2.

The contact spring 107 has a third contact pole, which faces the first contact pole and a fourth contact pole 103-4, which faces the second contact pole 103-2. Furthermore, the third contact pole may arranged laterally offset next to the fourth contact pole 103-4. In some cases, the third contact pole may be arranged in the longitudinal direction of the contact spring 107.

The contact spring 107 further comprises a spring element 109, which may be configured to produce a restoring force upon deflection of the contact spring 107 from a rest position, which drives the contact spring 107 back to the rest position. The spring element 109 may be arranged between the third contact carrier 101-3 and the third contact plug 111-3 and may be z-shaped in order to bridge a distance between the first switching plane 105-1 and the second switching plane 105-2.

The first contact plug 111-1, the second contact plug 111-2 and the third contact plug 111-3 may be arranged in the second switching plane 105-2. The second contact carrier 101-2 may be angled to overcome the distance between the second contact pole 103-2 in the second switching plane 105-2 and the second contact plug 111-2 in the first switching plane 105-1.

The switching contact arrangement 100 further comprises a coupling arm 115 and a lever arm 507, wherein the coupling arm 115 may be formed integrally with the third contact carrier 101-3 and the contact spring 107. The coupling arm can be coupled to an armature 501 of a magnet system 503 via the lever arm 507.

The coupling arm 115 may be arranged laterally offset next to the third contact carrier 101-3 and has a coupling region 119 for connection to a lever arm 507 of the magnet system 503.

The lever arm 507 may be configured to come to rest on at least one of the coupling arms 115, 323 and/or to be positively and/or materially connected to one of the coupling arms 115, 323. A deflection of the armature 501 can be transmitted via the lever arm 507 to at least one of the coupling arms 115, 323 in order to move the contact spring 107.

The coupling arm 115 may be configured to effect a translation of the contact spring 107 perpendicular to a longitudinal axis 505 of the armature 501 with a force acting on the coupling arm 115 by means of the armature 501, in order to connect the contact spring 107 electrically conductively with one of the contact carriers 101-1, 101-2, 101-3.

The second contact carrier 101-2 has an offset portion 117 which may be arranged between the contact portion 125 and the second contact plug 111-2. The contact portion 125 may be configured to receive the second contact pole 103-2. Furthermore, the offset portion 117 may be configured to provide a parallel offset of the contact portion 125 relative to the second contact plug 111-2 by means of two curved portions, so that the contact portion 125 in the second switching plane 105-2 and the second contact plug 111-2 may be arranged at least partially in the first switching plane 105-1.

Furthermore, the first contact plug 111-1 has a first offset portion 801-1, the second contact plug 111-2 has a first offset portion 801-2 and/or the third contact plug 111-3 has a third offset portion 801-3. The respective offset portions 801-1, 801-2, 801-3 may be configured to connect the respective contact plug 111-1, 111-2, 111-3 to the respective contact carrier 101-1, 101-2, 101-3, and to overcome a predetermined distance between the first switching plane 105-1 and the second switching plane 105-2.

The contact carriers 101-1, 101-2, 101-3 can be fixed to the relay housing 123 with a respective portion arranged in the first switching plane 105-1, wherein the offset portions 801-1, 801-2, 801-3 may be formed to arrange the respective contact plugs 111-1, 111-2, 111-3 at a distance from the first switching plane 105-1. In some examples the respective contact plugs 111-1, 111-2, 111-3 may be arranged in the second switching plane 105-2.

In one example, the offset portions 801-1, 801-2, 801-3 form cranks for the contact plugs 111-1, 111-2, 111-3. Furthermore, the contact plugs 111-1, 111-2, 111-3 have flat, rectangular ends. The contact plugs 111-1, 111-2, 111-3 can be arranged in one plane—e.g., in the second switching plane 105-2—with activation contacts 803-1, 803-2 of the magnet system 503.

In one example, the contact plugs 111-1, 111-2, 111-3 may be formed from a contact plug strip, which may be wound onto a reel in order to continuously form a plurality of contact plug groups from the contact carrier strip. Furthermore, the contact carriers 101-1, 101-2, 101-3 can be formed from a contact carrier strip, which may be wound onto a further reel in order to form continuously a plurality of contact carrier groups from the contact carrier strip.

### LIST OF REFERENCE NUMBERS

100 Switching contact arrangement
101-1 First contact carrier
101-2 Second contact carrier
101-3 Third contact carrier
103-1 First contact pole
103-2 Second contact pole
103-3 Third contact pole
103-4 Fourth contact pole
105-1 First switching plane
105-2 Second switching plane
107 Contact spring
109 Spring element
111-1 First contact plug
111-2 Second contact plug
111-3 Third contact plug
113-1 Connection point
113-2 Connection point
115 Coupling arm
117 Offset portion
119 Coupling region
121-1 Opening
121-2 Opening
121-3 Opening
121-4 Opening
121-5 Opening
123 Relay housing
125 Contact portion
200 Sub-method
201 First sheet metal blank
203-1 Assembly location
203-2 Assembly location
205 Fixing
207 Bending
300 Sub-method
301 Second sheet metal blank
303-1 Assembly location
303-2 Assembly location
305 Punching
307 Fixing
309 Bending
311 Connecting portion
313-1 Holding strut
313-2 Holding strut
313-3 Holding strut
313-4 Holding strut
315 Removal
317 Remaining portion
321 Contact spring strip
323 Coupling arm
400 Method
401 Contact carrier strip
403 Connecting
405 Separating
407 Separating
409 Inserting
411 Surface normal
500 Method
501 Armature
503 Magnet system
505 Longitudinal axis
507 Lever arm
509 Relay
511 Mounting
600 Method
601 Placing
603 Relay cover plate
701 Opening
703 Part-circular recess
705 Width reduced portion

What is claimed is:

1. A switching contact arrangement for a relay, comprising:
a first contact carrier comprising a first contact plug and a first contact pole, wherein the first contact pole is arranged in a first switching plane and the first contact plug is formed in one piece with the first contact carrier, and wherein the first contact carrier is electrically connected with the first contact plug;
a second contact carrier comprising a second contact plug and a second contact pole, wherein the second contact pole is arranged in a second switching plane that is spaced parallel to the first switching plane, and wherein the second contact carrier is electrically connected with the second contact plug;
a contact spring comprising a third contact carrier and a third contact plug, wherein the contact spring is arranged between the first switching plane and the second switching plane, and wherein:
the third contact carrier is electrically connected with the third contact plug, and
the contact spring comprises a third contact pole facing the first contact pole and a fourth contact pole facing the second contact pole, wherein the third contact pole is arranged laterally offset next to the fourth contact pole.

2. The switching contact arrangement of claim 1, wherein the contact spring comprises a spring element configured to produce a restoring force to drive the contact spring back to a rest position based at least in part on the contact spring being deflected from the rest position.

3. The switching contact arrangement of claim 1, wherein the first contact carrier and the second contact carrier are formed from a first sheet metal blank, and wherein the contact spring is formed from a second sheet metal blank.

4. The switching contact arrangement of claim 1, wherein the first contact plug, the second contact plug and the third contact plug are formed from a first sheet metal blank piece.

5. The switching contact arrangement of claim 1, wherein the first contact plug, the second contact plug, and the third contact plug are arranged in the first switching plane.

6. The switching contact arrangement of claim 1, wherein the third contact plug has at least one connection point configured to connect electrically and fix mechanically the third contact carrier with the third contact plug.

7. The switching contact arrangement of claim 1, wherein the first contact carrier in the first switching plane is L-shaped and the second contact carrier is angled to overcome a distance between the second contact pole in the second switching plane and the second contact plug in the first switching plane.

8. The switching contact arrangement of claim 1, wherein a spring element is arranged between the third contact carrier and the third contact plug and is formed z-shaped to bridge a distance between the first switching plane and the second switching plane.

9. The switching contact arrangement of claim 1, wherein the respective contact poles are riveted or welded, or both, on the respective contact carriers.

10. The switching contact arrangement of claim 1, further comprising:
a coupling arm coupled with an armature of a magnet system and configured to effect a translation of the contact spring perpendicular to a longitudinal axis of the armature by means of a force exerted by the armature on the coupling arm in order to connect electrically conductively the contact spring with one of the contact carriers.

11. The switching contact arrangement of claim 10, wherein the coupling arm is arranged laterally offset next to the third contact carrier and comprises a coupling region configured to receive a lever arm of the magnet system.

12. The switching contact arrangement of claim 1, wherein the contact spring in a rest position is electrically isolated from the first contact carrier or the second contact carrier, or both.

13. The switching contact arrangement of claim 1, wherein the first contact carrier, the second contact carrier, or the third contact carrier, or any combination thereof, comprise openings to receive pins of a relay housing, and wherein the switching contact arrangement is fixed in the relay housing based at least in part on the openings.

14. The switching contact arrangement of claim 1, further comprising:
a first offset portion arranged on the first contact plug and configured to offset the first contact plug by a predetermined distance from the first switching plane along a surface normal of the first switching plane.

15. The switching contact arrangement of claim 14, further comprising:
a second offset portion and a third offset portion, wherein the third offset portion is arranged laterally offset on the contact spring, or wherein the second contact plug is arranged on the second offset portion with a lateral offset, or wherein the offset portions are configured to offset the respective contact plug along a respective surface normal of the first switching plane by a respective predetermined distance from the first switching plane, or any combination thereof.

16. A method for producing a switching contact arrangement for a relay, comprising:
punching a first contact carrier and a second contact carrier in a contact carrier strip;
attaching a first contact pole to the first contact carrier and a second contact pole to the second contact carrier;
bending a contact portion of the second contact carrier into a second switching plane, wherein the second contact pole is arranged on the contact portion;
punching a contact spring in a contact spring strip;
attaching a third contact pole and a fourth contact pole to a third contact carrier of the contact spring;
bending the contact spring to form a spring element, wherein the third contact carrier, on which the third contact pole and the fourth contact pole are arranged, has a smaller distance to the second switching plane than a third contact plug to the second switching plane;
connecting the contact carrier strip with the contact spring strip at a connection point of the third contact plug;
separating the contact spring from the contact spring strip; and
separating the third contact plug from the contact carrier strip.

17. The method of claim 16, further comprising:
winding the contact spring strip onto a reel after the contact spring is punched in the contact spring strip.

18. The method of claim 16, further comprising:
winding the contact carrier strip on a reel after the stamping of the first contact carrier, the second contact carrier and the third contact carrier in the contact carrier strip.

19. An apparatus for producing a switching contact arrangement for a relay, comprising:
means for punching a first contact carrier and a second contact carrier in a contact carrier strip;
means for attaching a first contact pole to the first contact carrier and a second contact pole to the second contact carrier;
means for bending a contact portion of the second contact carrier into a second switching plane, wherein the second contact pole is arranged on the contact portion;
means for punching a contact spring in a contact spring strip;
means for attaching a third contact pole and a fourth contact pole to a third contact carrier of the contact spring;
means for bending the contact spring to form a spring element, wherein the third contact carrier, on which the third contact pole and the fourth contact pole are arranged, has a smaller distance to the second switching plane than a third contact plug to the second switching plane;
means for connecting the contact carrier strip with the contact spring strip at a connection point of the third contact plug;
means for separating the contact spring from the contact spring strip; and
means for separating the third contact plug from the contact carrier strip.

20. The apparatus of claim 19, further comprising:
a means for joint processing of the contact carrier strip with the contact spring strip.
